(19) United States
(12) Patent Application Publication
(10) Pub. No.: US 2017/0274739 A1
(43) Pub. Date: Sep. 28, 2017

(54) SUN SHADE DEVICE

(71) Applicant: Mikhail Mulokandov, Rego Park, NY (US)

(72) Inventor: Mikhail Mulokandov, Rego Park, NY (US)

(21) Appl. No.: 15/466,820

(22) Filed: Mar. 22, 2017

Related U.S. Application Data
(60) Provisional application No. 62/312,412, filed on Mar. 23, 2016.

(51) Int. Cl. B60J 1/20

(52) U.S. Cl. CPC B60J 1/2091

(57) ABSTRACT

An improved sun shade device is a folding, fan-style interior windshield shade for vehicles, structured and arranged for permanent, yet removable mounting at the base of the windshield, easy to deploy when needed, with a “peacock tail” design which provides full-coverage shading of the windshield, keeping interior temperatures lower and blocking damaging UV rays from the vehicle's interior.

### CROSS-REFERENCE TO RELATED APPLICATION

The present application is related to and claims priority from prior provisional application Ser. No. 62/312,412, filed Mar. 23, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of sun shades and more specifically relates to a folding fan-style interior windshield shade for cars, vans, pickups, SUVs, and other vehicles structured and arranged for permanent, yet removable mounting at the base of the windshield. Easy to deploy when needed, the efficient “peacock tail” design would provide full-coverage shading of the windshield, keeping interior temperatures lower and blocking damaging UV rays from the vehicle's interior.

2. Description of the Related Art

If the largest and most important single investment a consumer makes is in a house, the second largest, in most cases, will be in the vehicles they drive. Not only are home and car the most visible, expensive, and important of our possessions, but both require substantial upkeep on our part to retain their pleasing appearance and financial value. People throughout history have remarked that a person's self-respect extends to his or her possessions, pointing out that a self-respecting person is almost certain to have a neat and clean personal appearance, a clean and orderly home, and in our time, a neat and tidy car. A self-respecting person takes care of things, keeps his or her possessions in good shape, and considers it proper and necessary to have a place for everything and everything in its place. In our time, when a person's most significant possessions are his or her home and car, we keep these up with routine and regular maintenance. We have our car serviced regularly, and do our best to protect its body, paint, and finish.

A car would not be much good to us if we kept it protected in a garage and never drove it. We can do our best to park where the hazards are minimal, but taking a car out into the world is unavoidably to put that car at risk—and one of the risks, both to the car itself and our own comfort, is direct sunlight. Not only does the sun heat up the interior of a parked, locked vehicle—sometimes to lethal levels—but the heat and Ultraviolet (UV) rays can damage the vehicle's dashboard, steering wheel, and upholstery. To reduce the interior's exposure to the sun, many drivers, after parking, place a folding sun-screen behind the windshield. But while these screens are reasonably effective, they are also cumbersome to unfold and deploy, and bulky to carry around.

Various attempts have been made to solve the above-mentioned problems such as those found in U.S. Pat. No. 4,877,074 to Anthony J. Castellano; U.S. Pat. No. 5,751,488 to Craig Michael Wade; and U.S. Publication No. 2002/0171256 to Herbert Ward. This art is representative of sun shade devices used in vehicles. None of the above inventions and patents, taken either singly or in combination, is seen to describe the invention as claimed.

Ideally, a sun shade device should provide ease of installation, be durable, and yet would operate reliably and be manufactured at a modest expense. Thus, a need exists for a reliable improved sun shade device to avoid the above-mentioned problems.

### BRIEF SUMMARY OF THE INVENTION

In view of the foregoing disadvantages inherent in the known sun shade device art, the present invention provides a novel improved sun shade device. The general purpose of the present invention, which will be described subsequently in greater detail is to provide a folding, fan-style interior windshield shade for vehicles, structured and arranged for permanent yet removable mounting at the base of the windshield, easy to deploy when needed, with a “peacock tail” design which provides full-coverage shading of the windshield, keeping interior temperatures lower and blocking damaging UV rays from the vehicle's interior.

An improved sun shade device for a vehicle is disclosed herein comprising a base member adapted to be attached to the dashboard or a lower section of the windshield of a vehicle via a suction cup, or two-sided adhesive tape, and a pair of shade members pivotally connected at distal ends to the base member, positioned adjacent to one another and adapted to be extended into a deployed position to cover a large portion of the surface of a windshield to block sunlight from passing through the windshield and entering the interior compartment of the vehicle.

The pair of shade members are formed such that they are adapted to be extended into a deployed position of semi-circular shape as needed, and collapsed into a storage position when not in use. Further, the pair of shade members each has a center side portion adapted to be connected together with a clip member attached to a proximal end that are adapted to connect to one another, and each shade member also has magnetic members attached to the center side portions, such that the center side portions are able to be connected to one another in the deployed position.

The shade members each include an elongated cord member attached to a proximal end that are adapted to be hung over a rear view mirror of the vehicle, such that when each respective one of the elongated cord members is pulled, a respective one of the pair of shade members is extended into the deployed position. The pair of shade members are formed from a plurality of interconnected slat members that is folded into an accordion-shape, and is adapted to be unfolded into deployed position and folded into storage position as needed for use.

The shade members are formed from a group of materials consisting of cloth, cotton, bamboo, a mesh fabric, and a woven fabric having a reflective backing adapted to reflect sunlight away from the interior compartment of the vehicle. The base member is formed as a ball hinge adapted to allow the pair of shade members to pivot in a 360 degree fashion such that they are adjustable to match different slant angles of different windshields of different vehicles.

The present invention holds significant improvements and serves as an improved sun shade device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, improved sun shade device constructed and operative according to the teachings of the present invention.

FIG. 1 shows a perspective view illustrating an improved sun shade device in an in-use condition according to an embodiment of the present invention.

FIG. 2 is an inside view illustrating an improved sun shade device in a deployed position according to an embodiment of the present invention of FIG. 1.

FIG. 3 is an inside view illustrating improved sun shade device in a storage position according to an embodiment of the present invention of FIG. 1.

FIG. 4 is an exploded view illustrating improved sun shade device according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a sun shade device and more particularly to an improved sun shade device as used to improve the ability of a user to protect the interior of a vehicle with a folding fan style window shade that attaches adhesively, or with suction cups to the dashboard of a vehicle.

Generally speaking, improved sun shade device consists of two collapsible, folding fanstyle, semicircular “wings”—one mounted at the base of the windshield on the driver's side, the other on the passenger side. These “wings” are made up of aluminum or vinyl slats like those found in window-blinds. The exterior-facing surface of the individual slats will be reflective white or silver. Each of the two “wings” is designed to collapse when not in use, like a folding hand fan, to lie flat along the top of the dashboard, where the base is mounted by means of suction-cups or by a peel-and-stick adhesive backing. Each of the two “wings” is constructed of individual slats which, when pulled upward, pivot from a single point nearest the center of the windshield. In deployment, the slats fan upward and across the windshield, opening in the manner of a peacocks tail to form a semicircular shade; and the two “wings” operate in concert to shade the entire windshield.

The mechanism for lifting and collapsing the improved sun shade device is a pair of strings or cords—one for the driver side, one for the passenger side—which hang from the rear-view mirror. To deploy the shade members, the user will simply pull the two cords to lift the two “wings,” then clip the uppermost slat of each side's shade into a clip mounted at the top of the windshield. Detaching the uppermost slats from their clips will allow the shade members to collapse, and two similar clips in the base will secure and hold the two collapsed slat assemblies when the improved sun shade device is not in use.

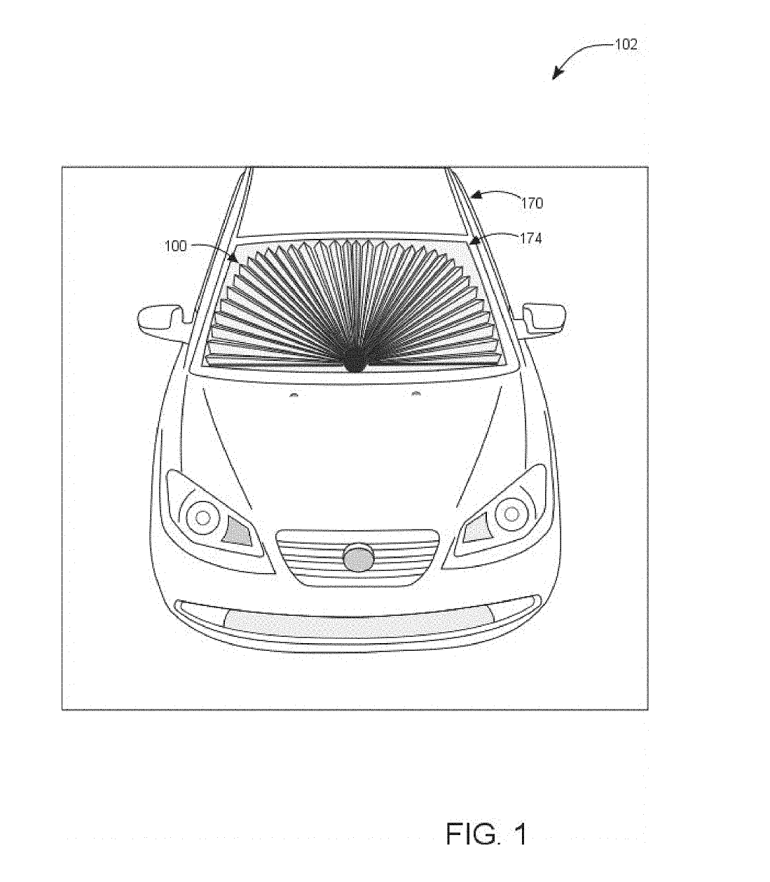

Referring to the drawings by numerals of reference there is shown in FIG. 1, a perspective view illustrating an improved sun shade device 100 in an in-use condition 102 according to an embodiment of the present invention.

Improved sun shade device 100 for vehicle 170 is disclosed herein comprising base member 106 adapted to be attached to dashboard 172 or a lower section of windshield 174 of vehicle 170 via suction cup 108, or two-sided adhesive tape 110, and a pair of shade members 120 pivotally connected at proximal ends 122 to base member 106, positioned adjacent to one another and adapted to be extended into deployed position 130 to cover a large portion of the surface of windshield 174 to block sunlight from passing through windshield 174 and entering the interior compartment of vehicle 170.

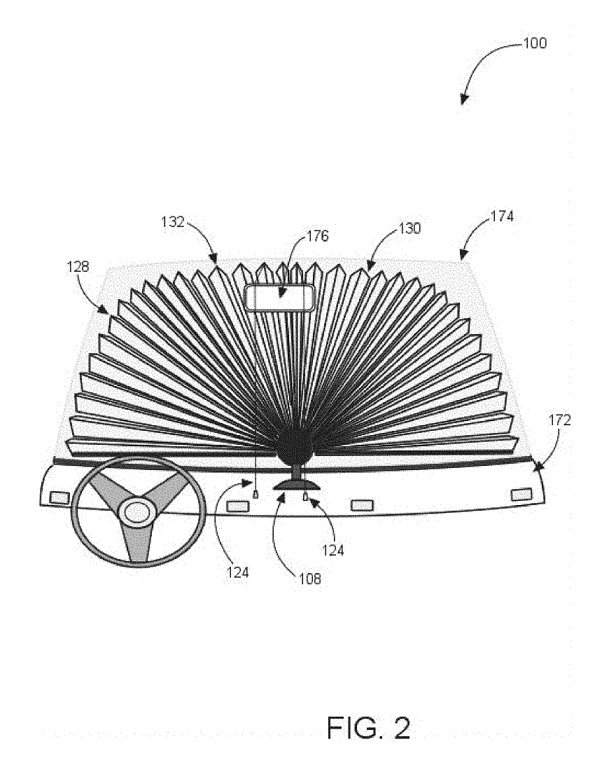

Referring now to FIG. 2, an inside view illustrating an improved sun shade device 100 in a deployed position 130 according to an embodiment of the present invention.

The pair of shade members 120 are formed such that they are adapted to be extended into deployed position 130 of semi-circular shape 132 as needed, and collapsed into storage position 140 when not in use. Further, the pair of shade members 120 each has center side portion 144 adapted to be connected together with clip member 146 attached to distal end 150 which are adapted to connect to one another. Each shade member 120 also has magnetic members 148 attached to center side portions 144, such that center side portions 144 are able to be connected to one another in deployed position 130.

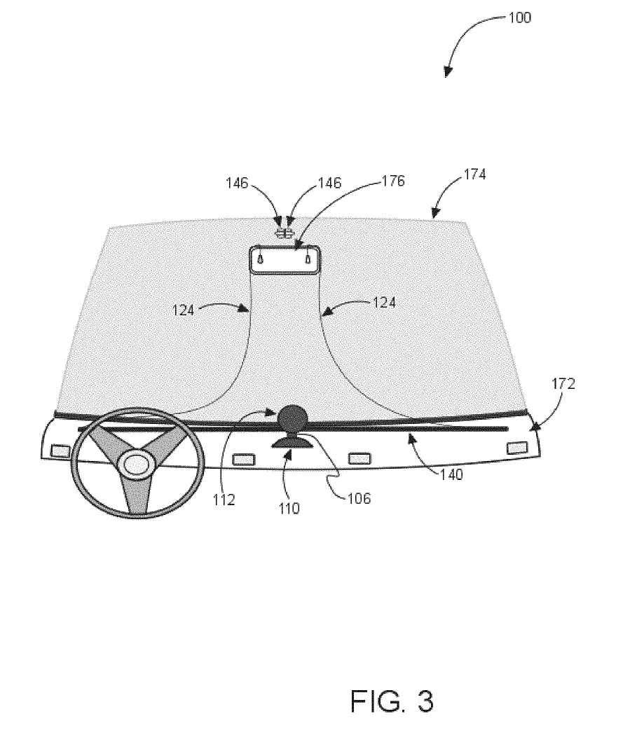

Referring now to FIG. 3, an inside view illustrating an improved sun shade device 100 in a storage position 140 according to an embodiment of the present invention.

Shade members 120 each include elongated cord member 124 attached to distal end 150 that are adapted to be hung over rear view mirror 176 of vehicle 170, such that when each respective one of elongated cord members 124 is pulled, a respective one of the shade members 120 is extended into deployed position 130. The shade members 120 are formed from a plurality of interconnected slat members 126 that is folded into an accordion-shape 128, and is adapted to be unfolded into deployed position 130 for use, and folded into storage position 140 when not in use.

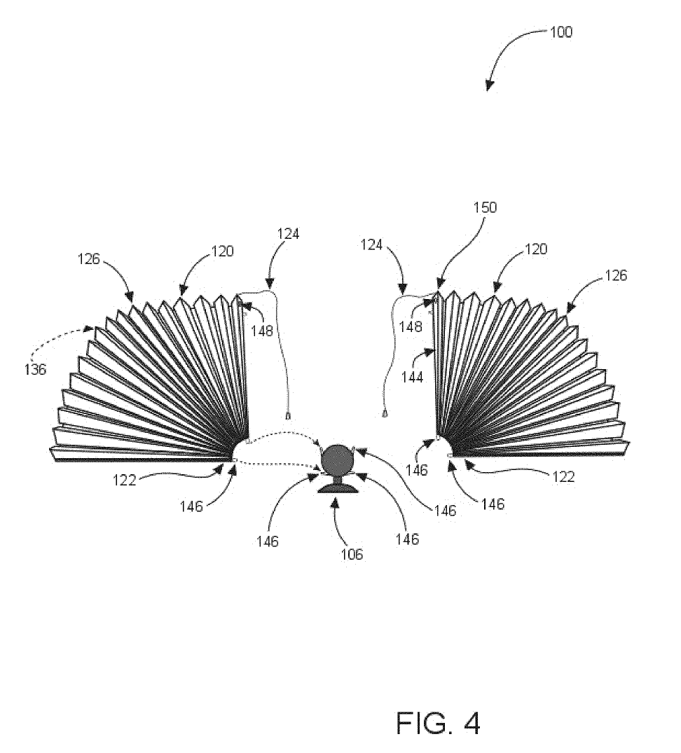

Referring now to FIG. 4, an exploded view illustrating an improved sun shade device 100 according to an embodiment of the present invention.

Shade members 120 are formed from a group of materials consisting of cloth, cotton, bamboo, a mesh fabric, and a woven fabric having a reflective backing 136 adapted to reflect sunlight away from the interior compartment of vehicle 170. Base member 106 is formed as ball hinge 112 adapted to allow the pair of shade members 120 to pivot in a 360 degree fashion such that they are adjustable to match different slant angles of different windshields 174 of different vehicles 170.

Improved sun shade device 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An improved sun shade device for a vehicle, comprising:
a base member;
wherein said base member is adapted to be releasably attached to a dashboard or a lower section of a windshield of said vehicle;
a pair of shade members;
wherein said pair of shade members are pivotally connected at proximal ends thereof to said base member;
wherein said pair of shade members are positioned adjacent to one another;
wherein said pair of shade members are formed such that they are adapted to be extended into a deployed position and collapsed into a storage position;
wherein each of said pair of shade members has a center side portion such that said center side portions are adapted to be connected together;
wherein said improved sun shade device is adapted to be releasably attached to a dashboard or a lower section of said windshield of said vehicle, and said pair of shade members extended into said deployed position to cover a large portion of a surface of said windshield to thereby block sunlight from passing through said windshield and entering an interior compartment of said vehicle.

2. The improved sun shade device of claim 1, wherein said base member is adapted to be releasably attached to said dashboard or said lower section of said windshield of said vehicle via a suction cup.

3. The improved sun shade device of claim 1, wherein said base member is releasably attached to said dashboard or said lower section of said windshield of said vehicle via a two-sided adhesive tape.

4. The improved sun shade device of claim 1, wherein said pair of shade members each have a semi-circular shape.

5. The improved sun shade device of claim 1, wherein each of said pair of shade members includes a clip member attached to a distal end thereof that are adapted to releasably connect to one another, such that said center side portions are adapted to be releasably connected to one another in said deployed position.

6. The improved sun shade device of claim 1, wherein each of said pair of shade members includes an elongated cord member attached to a distal end thereof that are adapted to be hung over a rear view mirror of said vehicle, and adapted such that when each respective one of said elongated cord members is pulled a respective one of said pair of shade members is extended into said deployed position.

7. The improved sun shade device of claim 1, wherein said pair of shade members are formed from a material that is folded into an accordion-shape that is adapted to be unfolded into said deployed position and folded into said storage position.

8. The improved sun shade device of claim 1, wherein said pair of shade members are formed from a plurality of interconnected slat members adapted to be pivoted in one direction into said deployed position and pivoted in an opposite direction into said storage position.

9. The improved sun shade device of claim 1, wherein said pair of shade members are formed from a reflective material adapted to reflect sunlight away from said interior compartment of said vehicle.

10. The improved sun shade device of claim 1, wherein said pair of shade members are formed from a material chosen from a group of materials consisting of cloth, cotton, bamboo, a mesh fabric, and a woven fabric.

11. The improved sun shade device of claim 1, wherein each of said pair of shade members includes a magnetic member attached to a distal end thereof that are adapted to releasably connect to one another, such that said center side portions are adapted to be releasably connected to one another in said deployed position.

12. The improved sun shade device of claim 1, wherein said base member is formed as a ball hinge adapted to allow said pair of shade members to pivot in a 360 degree fashion such that they are adapted be adjustable to match different slant angles of different windshields of different vehicles.

13. The improved sun shade device of claim 5, further comprising a windshield clip member adapted to be removably connected to an upper section of said windshield and adapted to releasably connect with said clip member of each of said pair of shade members, to thereby be adapted to hold said pair of shade members in said deployed position with respect to said windshield.

14. The improved sun shade device of claim 13, wherein said windshield clip member is adapted to be removably connected to an upper section of said windshield via a suction cup.

15. The improved sun shade device of claim 13, wherein said windshield clip member is adapted to be removably connected to an upper section of said windshield via two-sided adhesive tape.
